(19) United States
(12) Patent Application Publication
(10) Pub. No.: US 2005/0254517 A1
(43) Pub. Date: Nov. 17, 2005

(54) Digital camera and digital video recorder for storing multimedia message

(75) Inventor: An-Jin Hu, Dong - Guan (CN)

Correspondence Address: RADER FISHMAN & GRAUER PLLC, LION BUILDING, 1233 20TH STREET N.W., SUITE 501, WASHINGTON, DC, 20036, US

(73) Assignee: Asia Optical Co., Inc.

(21) Appl. No.: 11/092,936

(22) Filed: Mar. 30, 2005

(30) Foreign Application Priority Data
May 13, 2004 (TW) 93113439

(51) Int. Cl. H04J 3/16

(52) U.S. Cl. 370/466; 370/487

(57) ABSTRACT

A digital camera and a digital video recorder are disclosed, including an input unit, a user interface, an analysis unit, an encoding unit and a storage unit. An analog data is transmitted to the input unit and converted to the digital data. User may choose whether to store the digital data in multimedia message forms by using the user interface. The analysis unit analyzes the digital data and determines the corresponding file format for the multimedia message. The encoding unit encodes the digital data to the multimedia message in the determined file format. Consequently, the multimedia message and/or the digital data are stored in the storage unit.

### CROSS REFERENCE TO RELATED APPLICATIONS

This application claims priority of Taiwan Patent Application Serial No. 093113439 entitled “Digital Camera and Digital Video Recorder for Storing Multimedia Message”, filed on May 13, 2004.

### FIELD OF THE INVENTION

The present invention relates to a digital recording device for storing multimedia message, and particularly to a digital camera or a digital video recorder.

### BACKGROUND OF THE INVENTION

Digital recording devices, including digital camera and digital video recorder, have become more and more powerful then ever. While the image pixel resolution of the device increases and the peripheral functionality expands, the selling price keeps going down. As a result, the digital recording device has replaced the conventional devices, e.g. the analog devices, and became a popular consumer electronic product.

On the other hand, the advanced mobile phone, e.g. 3G, also has multimedia functionality such as multimedia message service (MMS). Users are able to transmit all kinds of pictures or videos to others via the MMS. Although some of the mobile phones are equipped with camera to retrieve images, however, the built-in camera is usually a basic type with lower pixel resolution, less functionalities, with no optical zoom function. That causes the images captured by the mobile phone to be blur, unclear, and not qualified for high-quality images. Further, the small memory space is another issue due to cost consideration. Contrarily, although the digital recording device may provide high quality image, lacking of data transmission capability disallows the retrieved image to be sent elsewhere.

FIG. 4 shows a conventional digital recording device. Users may use the digital recording device 40 to capture high quality images and then the images are sent to a personal computer 42. The personal computer 42 then edits and converts the images into multimedia messages 404, which are acceptable or supported by the mobile phone 44. At last, the multimedia messages 404 are transferred to the mobile phone 44. It is inconvenient for general users not familiar with computer operations to use the additional personal computer 42 while preparing the multimedia message.

Therefore, it is beneficial to have a stand-alone digital recording device capable of converting the captured images to multimedia messages. The digital recording device may have a transmission interface, through which the multimedia message may be transferred to the mobile communication device. Further, the images captured by a mobile communication device may be transferred to and stored in the digital recording device through the transmission interface. Thus, the digital recording device may be utilized as an external storage to the mobile communication device, and the insufficient memory issue of the mobile communication device may be resolved.

### SUMMARY OF THE INVENTION

One aspect of the present invention is to provide a digital recording device for selectively storing images as multimedia messages, and users may choose to store the images as multimedia messages for future use.

Another aspect of the present invention is to provide a digital recording device for storing multimedia messages and communicating with a mobile communication device, and users may utilize the mobile communication device to send the multimedia message stored in the digital recording device.

Still another aspect of the present invention is to provide a digital recording device for storing multimedia messages and communicating with a mobile communication device, and users may backup the data of the mobile communication device on the digital recording device to resolve the issue of insufficient memory space of the mobile communication device.

A digital recording device is disclosed, including an input unit, a user interface, an analysis unit, an encoding unit, a storage unit, an edit unit, and a transmission unit. Analog data are transmitted to the input unit and converted to digital data, and then the digital data are stored in the storage unit of the digital recording device. The user interface allows a user to select whether to store the digital data as one multimedia message. The user interface further provides a browse function for the user to browse a plurality of digital data stored in the storage unit, and the user is able to select one of the digital data for encoding the selected digital data into a multimedia message. The analysis unit analyzes the selected digital data to determine a file format corresponding to the multimedia message. After the analysis process, the encoding unit encodes the analyzed digital data into a multimedia message based on the determined file format. At last, the multimedia message is stored in the storage unit of the digital recording unit.

The user interface may further allow the user to determine whether to edit the digital data and the multimedia message stored in the storage unit. The edit unit may edit the selected digital data (or multimedia message), including modifying the digital data, capturing a portion of the digital data, or combining a plurality of digital data before encoding into the multimedia message.

The digital recording device may connect to a mobile communication device through the transmission unit, such as a transmission cable, a USB line, an infrared communication channel, etc. The user interface may further allow the user to browse the digital data and multimedia messages stored in the storage unit, and the user may select a multimedia message (or digital data) to be transferred to the mobile communication device, or download the data from the mobile communication device for backup purpose. The digital recording device transfers the selected multimedia message through the transmission unit to the mobile communication unit. The data to be backed up goes through the inverse direction. Furthermore, the digital recording device may store the multimedia messages on a removable storage unit.

### BRIEF DESCRIPTION OF THE DRAWINGS

FIG. 1A illustrates a block diagram of a digital recording device in accordance with an embodiment of the present invention;

FIG. 1B illustrates a digital camera in accordance with an embodiment of the present invention is connected to a mobile communication device;

FIG. 1C illustrates a digital video recorder in accordance with another embodiment of the present invention is connected to a mobile communication device;

FIG. 2 illustrates a flowchart of process for storing a multimedia message in a digital recording device in accordance with the present invention;

FIG. 3 illustrates a flowchart of process for editing a multimedia message in a digital recording device in accordance with the present invention; and

FIG. 4 illustrates schematically how to transfer a multimedia message from a conventional digital recording device to a mobile phone.

### DETAILED DESCRIPTION OF THE INVENTION

The present invention resolves the problems described above so that the multimedia message may be edited or used easily on the digital recording devices, e.g. digital video recorder or digital camera.

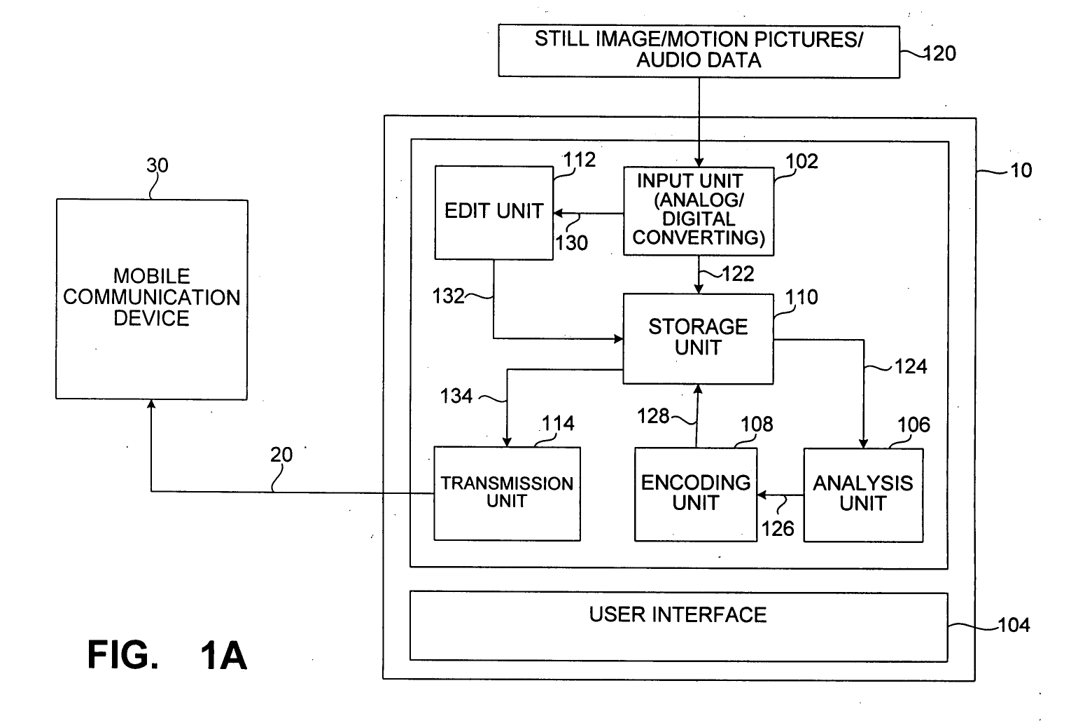

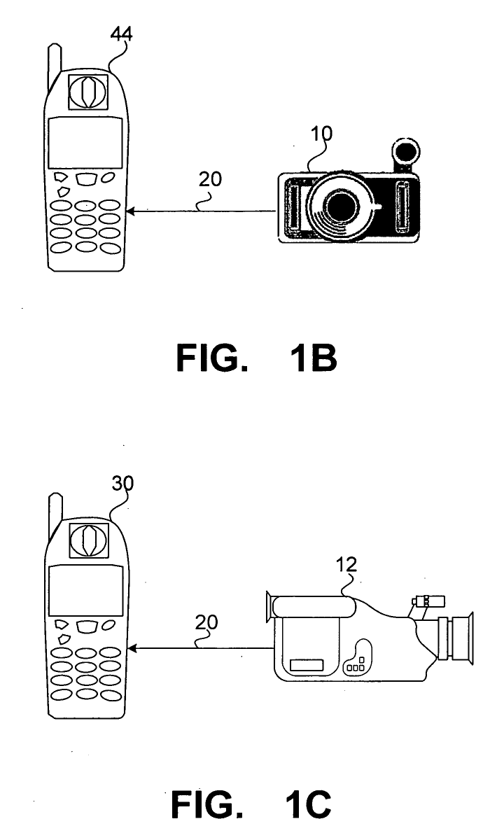

FIG. 1A illustrates a block diagram of a digital recording device 10 in accordance with an embodiment of the present invention. The digital recording device 10 includes an input unit 102, a user interface 104, an analysis unit 106, an encoding unit 108, a storage unit 110, an edit unit 112, and a transmission unit 114. Analog data 120 are transmitted to the input unit 102 and converted to digital data 122, and then the digital data 122 are stored in the storage unit 110. The analog data 120 accepted by the digital recording device 10 may include still images, motion pictures, audio signal, or the combination thereof. The input unit 102 may include sensors for different type of analog data 120, such as Charge Coupled Device (CCD) or Complementary Metal-Oxide Semiconductor (CMOS) sensors for sensing the image, a microphone for sensing the sound. The input unit 102 may further include analog/digital (A/D) converter for converting the analog data 120 to the digital data 122. The other aspects of the input unit 102 are well known to those skilled in the art and omitted here for conciseness.

The user interface 104 allows a user to select whether to store the digital data 122 as one multimedia message 128. The user interface 104 may further provide a browse function for the user to browse a plurality of digital data 122 stored in the storage unit 110, and the user is able to select one of the digital data 122 to encode the selected digital data 124 into the multimedia message 128. Once the user selects the digital data 124 for encoding process, the selected digital data 124 are sent to the analysis unit 106 for analysis process 124. According the type of selected digital data 124, an appropriate file format corresponding to the multimedia message 128 is determined. In this embodiment, the multimedia message 128 conforms to the Multimedia Message Service (MMS). For example, the MMS Media Format and Codecs for CDMA2000 Spread Spectrum Systems version 1 (C. S0045-0 V1.0) issued by the 3^{RD} Generation Partnership Project 2 (3GPP2). In this embodiment, the file format may include 3GPP2 or AMR format for voice type, MPEG-4 AAC Low Complexity Object Type format for audio type, or Scalable Polyphony MIDI (SP-MIDI) format for synthetic audio type. When the selected digital data 124 are still image data, the file format may include ISO/IEC JPEG, GIF 87a, GIF 89a, PNG, or the likes. When the selected digital data 124 are multimedia data, the file format may include ITU-T standard, MPEG4 standard, or the likes. It should be noted that the file formats are introduced for illustrating purpose and the present invention may be implemented according to any other multimedia message standards. After the analysis process is completed, the analyzed digital data 126 are sent to the encoding unit 108. The encoding unit 108 encodes the analyzed digital data 126 into the multimedia message 128 based on the file format determined by the analysis unit 106. At last, the multimedia message 128 is stored in the storage unit 110.

The user interface 104 may further allow the user to determine whether to edit the digital data 122 or the multimedia message 128 stored in the storage unit 110, or whether to edit the digital data 122 before encoding by the encoding unit 108. When the editing process begins, the selected digital data (or multimedia message) 130 are sent to the edit unit 112. The edit unit 112 edits the selected digital data 130, including modifying the digital data 130 (e.g. adjusting the brightness of the image), capturing a portion of the digital data 130 (e.g. cutting a portion of audio signal), or combining a plurality of digital data 130 (e.g. combining a plurality of video signals into a single movie clip). The post-edited digital data 132 are sent back to storage unit 110 for storing again. The edit unit 112 allows the user to modify and personalize the selected digital data (or multimedia message) 130, such as adding frames, stamps, descriptions, etc.

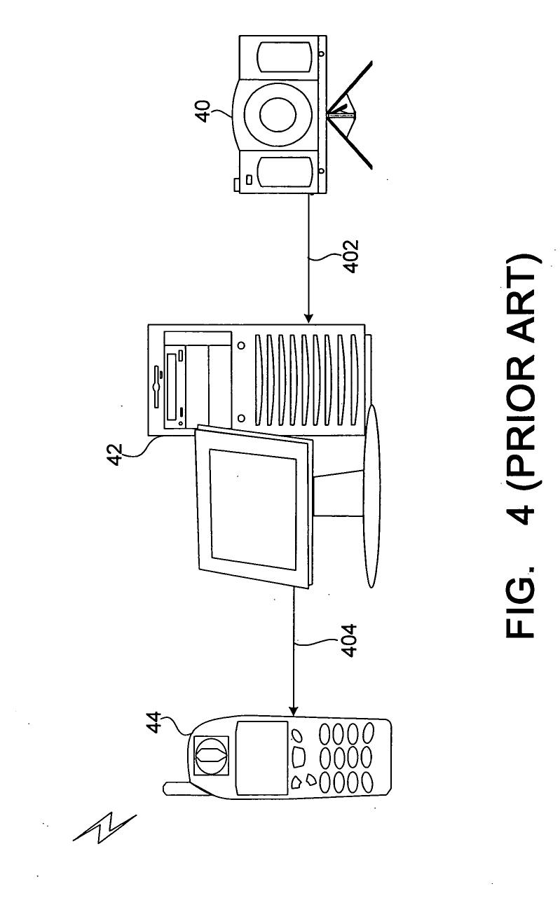

Furthermore, the digital recording device 10 may connect to a mobile communication device 30, such as a mobile phone or PDA, through the transmission medium 20, such as a transmission cable, a USB line, an infrared communication channel, etc. In this embodiment, a transmission cable is implemented for illustrating purpose. The user interface 104 may further allow the user to browse the digital data 122 stored in the storage unit 110, and the user may select and transfer a multimedia message (or digital data) 134 to the mobile communication device 30. The multimedia message 134 is sent to the transmission unit 114 first, and then to the mobile communication device 30 through the transmission medium 20. In this way, the digital recording device 10 can still generate a multimedia message without connecting to a computer. Users may directly utilize the stand-alone digital recording device 10 to edit or encode the image. In the past, users need to use a camera for high quality images and use a mobile phone for multimedia messages processing. Alternatively, the digital recording device 10 may download data from the mobile communication device 30 through the transmission medium 20 for backup purpose. The issue of insufficient memory space of the mobile communication device 30 may be resolved. Comparing to the prior art's digital recording device 40 shown in FIG. 4, the digital recording device 10 in accordance with the present invention effectively uses the mass storage therein to backup the multimedia messages from the mobile communication device 30. The mobile communication device 30 transfers the data to the digital recording device 10 through the transmission medium 20, and then to the storage unit 110 through the transmission unit 114. Note that the backup data of multimedia messages are used here for exemplary purpose, those who skilled in the art, however, may realize that the present invention may be equally implemented to backup other data, such as address book, calendar, ringtones, plain-text messages, voice messages, or the likes.

As described above, the digital recording device 10 in accordance with the present invention may include digital camera, digital video recorder, or the likes. Referring to FIG. 1B and FIG. 1C, FIG. 1B illustrates a digital camera 10 in accordance with an embodiment of the present invention is connected to a mobile communication device 30. FIG. 1C illustrates a digital video recorder 12 in accordance with another embodiment of the present invention is connected to a mobile communication device 30.

Furthermore, referring to FIG. 1A, the storage unit 110 of digital recording device 10 of the present invention may include a removable storage unit (not shown), such as flash memory cards, e.g. Compact Flash, Memory Stick, Smart Media, Security Disk, and so on. The removable storage unit may be inserted into a memory slot of the mobile communication device 30, which may access the multimedia messages in the removable storage unit.

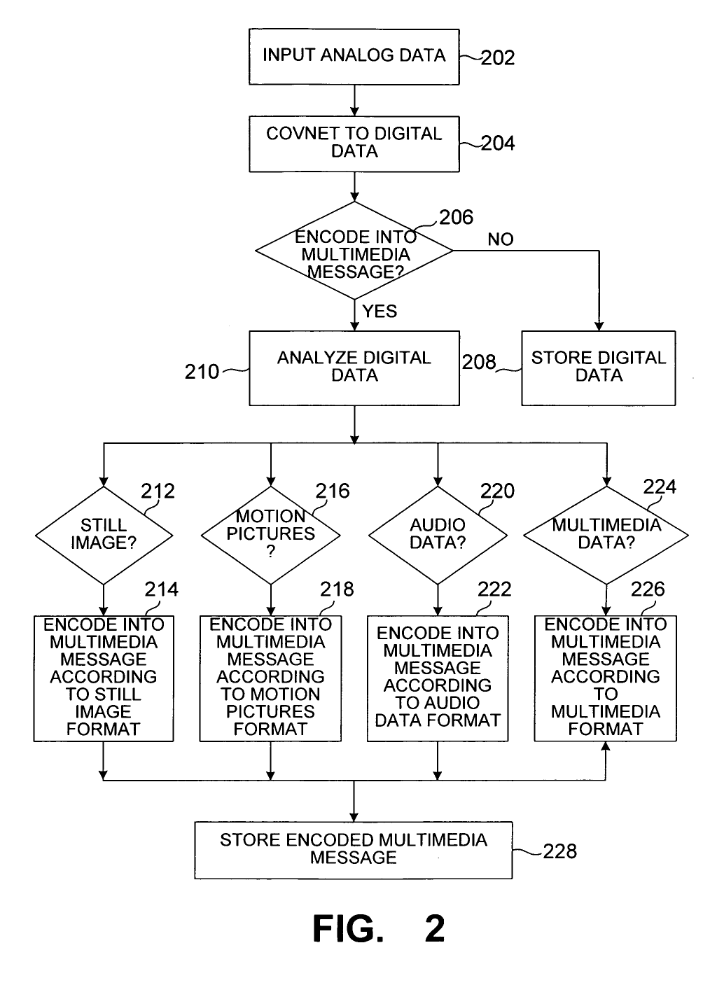

FIG. 2 illustrates a flowchart of process for storing a multimedia message in a digital recording device in accordance with the present invention. The method begins at step 202, by which analog data 120 are inputted into the digital recording device 10 through the input unit 102. In step 204, the analog data 120 are converted into digital data 122. In step 206, the user interface 104 allows the user to determine whether to encode the digital data 122 into a multimedia message 128. If not, the digital data 122 are directly stored in the storage unit 110 in step 208. Otherwise, the digital data 122 are transferred to the analysis unit 106 for analyzing an appropriate file format in step 210.

In step 212, the analysis unit 106 determines whether the digital data 122 is a still image. If yes, the digital data 122 are transferred to encoding unit 108 for encoding based on the appropriate file format in step 214. Various file formats are afore-described and omitted here for conciseness. In step 216, the analysis unit 106 determines whether the digital data 122 are a motion picture. If yes, the digital data 122 are transferred to encoding unit 108 for encoding based on the appropriate file format in step 218. In step 220, the analysis unit 106 determines whether the digital data 122 are audio data. If yes, the digital data 122 are transferred to encoding unit 108 for encoding based on the appropriate file format in step 222. In step 224, the analysis unit 106 determines whether the digital data 122 are multimedia data. If yes, the digital data 122 are transferred to encoding unit 108 for encoding based on the appropriate file format in step 226. Note that four types of file formats are mentioned here for illustrative purpose, and those who skilled in the art should understand that other types of multimedia messages may be implemented in the present invention. In step 228, the encoded multimedia messages are stored in the storage unit 110. Although not shown in the flowchart, the digital data 122 may be stored in the storage unit 110 for future use.

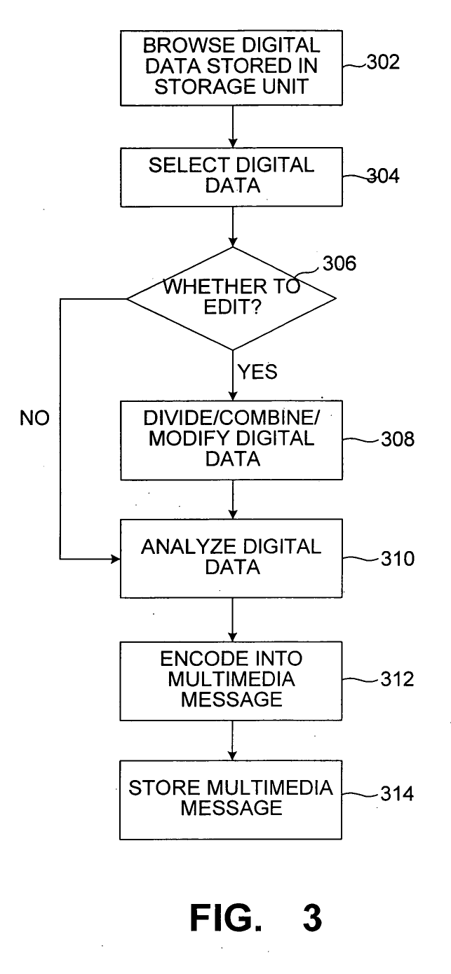

FIG. 3 illustrates a flowchart of process for editing a multimedia message in a digital recording device in accordance with the present invention. The process beginning at step 302, in which the user interface 104 allows a user to browse a plurality of digital data stored in the storage unit 110. In step 304, the user selects a digital data for editing or encoding. In step 306, the user determines whether to edit the selected digital data. If yes, the selected digital data are sent to the edit unit 112 in step 308 for the editing operations mentioned above, such as dividing, combining, or modifying the digital data. After the editing operation, the digital data are sent to the analysis unit 106 in step 310 for analyzing an appropriate file format. Alternatively, if the user determines not to edit the digital data in step 306, the process goes directly to step 310. In step 312, the encoding unit 108 encodes the digital data into the multimedia message. In step 314, the multimedia message is stored in the storage unit 110 for future use, e.g. transfer of messages to mobile communication device 30 through the transmission unit 114. It should be noted that the multimedia message may be edited in a similar way.

The above description sets forth various preferred embodiments of the invention only, and is not intended to limit the scope, applicability, or configuration of the invention in any way. Rather, various changes may be made in the function and arrangement of the elements described in these embodiments without departing from the spirit and scope of the invention. Thus, the protected scope of the present invention is as set forth in the appended claims.

1. A digital recording device for storing multimedia messages by connecting to a mobile communication device via a transmission unit, comprising:
an input unit for inputting a digital data, converted from an analog data, into the digital recording device;
a user interface allowing a user to select whether to store the digital data as one multimedia message;
an analysis unit for analyzing the digital signal to determine a file format corresponding to said one multimedia message;
an encoding unit for encoding the digital data into a multimedia message based on the determined file format;
a storage unit for storing the multimedia message and the digital data.

2. The digital recording device of claim 1, wherein the digital data including one of an image data, a video data, an audio data, and a multimedia data.

3. The digital recording device of claim 1, wherein the multimedia message conforms to protocols of Multimedia Message System.

4. The digital recording device of claim 3, wherein the transmission unit is adapted to sends the multimedia message to the mobile communication device.

5. The digital recording device of claim 3, wherein the transmission unit is adapted to receive a multimedia message from the mobile communication device for storing in the digital recording device.

6. The digital recording device of claim 1, wherein the user interface is adapted to provide a browse function for a user to browse a plurality of digital data stored in the storage unit, and the user is able to select one of the digital data for encoding the selected digital data into a multimedia message.

7. The digital recording device of claim 1, further comprising an edit unit for modifying the digital data, capturing a portion of the digital data, or combining a plurality of digital data before encoding into the multimedia message.
